(19) United States
(12) Patent Application Publication
(10) Pub. No.: US 2026/0014864 A1
(43) Pub. Date: Jan. 15, 2026

(54) ROAD CONDITION WARNING ON REFLECTIVE AND AUGMENTED HEAD-UP DISPLAYS

(71) Applicant: GM Global Technology Operations LLC, Detroit, MI (US)

(72) Inventors: Joseph F. Szczerba, Grand Blanc, MI (US); Thomas A. Seder, Fraser, MI (US); Kai-Han Chang, Madison Heights, MI (US); Guy N. Kennerly, Southfield, MI (US)

(73) Assignee: GM Global Technology Operations LLC, Detroit, MI (US)

(21) Appl. No.: 18/768,949

(22) Filed: Jul. 10, 2024

(51) Int. Cl. B60K 35/28; B60K 35/23; G02B 27/01; G06T 7/70; G06T 11/00; G06V 20/58

(52) U.S. Cl. CPC B60K 35/28; B60K 35/23; G02B 27/0101; G06T 7/70; G06T 11/00; G06V 20/58; B60K 2360/177; B60K 2360/178; B60K 2360/741; G02B 2027/0138; G02B 2027/014; G02B 2027/0141; G06T 2207/30201; G06T 2207/30268

(57) ABSTRACT

A system and method include receiving road data indicating a road hazard moving toward the vehicle, determining, based on the road data, that the road hazard is within a roadway of the vehicle, and determining a distance between the vehicle and the road hazard. The system and method also include receiving driver features of a driver of the vehicle from a driver tracker system, and simultaneously displaying, via head-up displays, a graphical alert alerting the driver of the vehicle to the road hazard, the graphical alert including an augmented reality image overlay and a virtual image, the augmented reality image overlay different from the virtual image.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method of road condition warnings on reflective and augmented head-up displays. Generally, when a vehicle is moving, its 360-degree sensing system continuously receives sensor data indicative of the vehicle's environment. For example, the sensor data may indicate that the vehicle's environment includes an upcoming hazard such as one or more other vehicles (e.g., a crash), a pothole, an animal or object, a fire, rocks, poor traction, as well as work zones including reduced speed zones, construction barrels, road workers, and/or lane closures. Notably, in either situation, systems that alert the driver to the road hazard provide the driver with critical additional time to take one or more corrective actions.

Moreover, for safety reasons, it is critical that any systems that use visual alert methods do not distract the driver's focus from the roadway in front of the vehicle. To this end, systems that integrate the driver's line of sight to place alerts to work zones and/or other road hazards may significantly reduce accidents. As such, providing alerts using the pillar-to-pillar display capabilities may integrate safety alerts with the driver's view with the roadway while limiting distractions.

### SUMMARY

One aspect of the disclosure provides a computer-implemented method for a road condition warning on reflective and augmented head-up displays that when executed on data processing hardware causes the data processing hardware to perform operations that include receiving road data including one or more of sensor data detected by a sensor system of a vehicle and third party data, the road data indicating a road hazard moving toward the vehicle, and determining, based on the road data, that the road hazard is within a roadway of the vehicle. The operations also include determining a distance between the vehicle and the road hazard, receiving driver features of a driver of the vehicle from a driver tracker system, and simultaneously displaying, via head-up displays, a graphical alert alerting the driver of the vehicle to the road hazard, the graphical alert including an augmented reality image overlay and a virtual image, the augmented reality image overlay different from the virtual image.

Implementations of the disclosure may include one or more of the following optional features. In some implementations, the head-up displays include an augmented reality head-up display and a blackout head-up display. In these implementations, simultaneously displaying, via the head-up displays, the graphical alert alerting the driver of the vehicle to the road hazard may further include generating the augmented reality image overlay, generating the virtual image, and projecting the augmented reality image overlay and the virtual image on a windshield of the vehicle simultaneously. Projecting the augmented reality image overlay and the virtual image on the windshield of the vehicle simultaneously may also include projecting the augmented reality image overlay on a clear portion of the windshield and projecting the virtual image on a blackout portion of the windshield. Additionally or alternatively, projecting the augmented reality image overlay and the virtual image on a windshield of the vehicle simultaneously may include determining, based on the driver features, a location of the windshield that corresponds to a line of sight of the driver, and projecting the augmented reality image overlay on the location of the windshield that corresponds to the line of sight of the driver.

In some examples, the sensor system includes one or more of cameras, radio detection and ranging (RADAR), and light detection and ranging (LIDAR). In some implementations, the operations further include receiving vehicle data, calculating, based on the vehicle data, a trajectory of the vehicle, and determining whether the road hazard and the vehicle will interact. In these implementations, the operations may further include determining, based on the distance between the vehicle and the road hazard and the trajectory of the vehicle, a time to interaction between the road hazard and the vehicle, and generating the graphical alert based on the time to interaction between the road hazard and the vehicle. In some examples, displaying, via the head-up displays, the graphical alert alerting the driver of the vehicle to the road hazard further includes displaying the graphical alert on a windshield of the vehicle to indicate a location of the road hazard. In some implementations, the graphical alert is configured to convey one or more of a distance to the road hazard, a rate of approach of the road hazard, a severity of the road hazard, and a type of the road hazard.

Another aspect of the disclosure provides a system for a road condition warning on reflective and augmented head-up displays that includes data processing hardware and memory hardware in communication with the data processing hardware. The memory hardware stores instructions that when executed by the data processing hardware cause the data processing hardware to perform operations that include receiving road data including one or more of sensor data detected by a sensor system of a vehicle and third party data, the road data indicating a road hazard moving toward the vehicle, and determining, based on the road data, that the road hazard is within a roadway of the vehicle. The operations also include determining a distance between the vehicle and the road hazard, receiving driver features of a driver of the vehicle from a driver tracker system, and simultaneously displaying, via head-up displays, a graphical alert alerting the driver of the vehicle to the road hazard, the graphical alert including an augmented reality image overlay and a virtual image, the augmented reality image overlay different from the virtual image.

This aspect may include one or more of the following optional features. In some implementations, the head-up displays include an augmented reality head-up display and a blackout head-up display. In these implementations, simultaneously displaying, via the head-up displays, the graphical alert alerting the driver of the vehicle to the road hazard may further include generating the augmented reality image overlay, generating the virtual image, and projecting the augmented reality image overlay and the virtual image on a windshield of the vehicle simultaneously. Projecting the augmented reality image overlay and the virtual image on the windshield of the vehicle simultaneously may also include projecting the augmented reality image overlay on a clear portion of the windshield and projecting the virtual image on a blackout portion of the windshield. Additionally or alternatively, projecting the augmented reality image overlay and the virtual image on a windshield of the vehicle simultaneously may include determining, based on the driver features, a location of the windshield that corresponds to a line of sight of the driver, and projecting the augmented reality image overlay on the location of the windshield that corresponds to the line of sight of the driver.

In some examples, the sensor system includes one or more of cameras, radio detection and ranging (RADAR), and light detection and ranging (LIDAR). In some implementations, the operations further include receiving vehicle data, calculating, based on the vehicle data, a trajectory of the vehicle, and determining whether the road hazard and the vehicle will interact. In these implementations, the operations may further include determining, based on the distance between the vehicle and the road hazard and the trajectory of the vehicle, a time to interaction between the road hazard and the vehicle, and generating the graphical alert based on the time to interaction between the road hazard and the vehicle. In some examples, displaying, via the head-up displays, the graphical alert alerting the driver of the vehicle to the road hazard further includes displaying the graphical alert on a windshield of the vehicle to indicate a location of the road hazard. In some implementations, the graphical alert is configured to convey one or more of a distance to the road hazard, a rate of approach of the road hazard, a severity of the road hazard, and a type of the road hazard.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system using a non-line-of-sight imminent crash warning using reflective head-up displays.

FIG. 2 is a schematic view of example components of the system of FIG. 1.

FIG. 3 is a road condition model flowchart for the system of FIG. 1.

FIGS. 4A-4D are schematic views of head-up displays of the system of FIG. 1.

FIGS. 5A and 5B are example views of the head-up displays of FIG. 4A.

FIGS. 6A and 6B are example views of the head-up displays of FIG. 4B.

FIGS. 7A and 7B are example views of the head-up displays of FIG. 4C.

FIGS. 8A and 8B are example views of the head-up displays of FIG. 4D.

FIG. 9 is a flowchart of an example arrangement of operations for a method of a road condition warning on reflective and augmented head-up displays.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or road hazards. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or road hazard-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

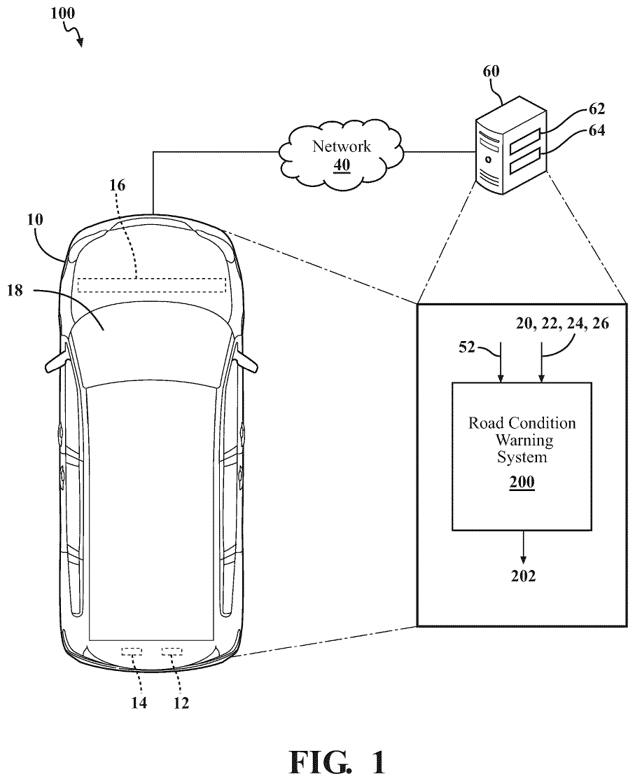

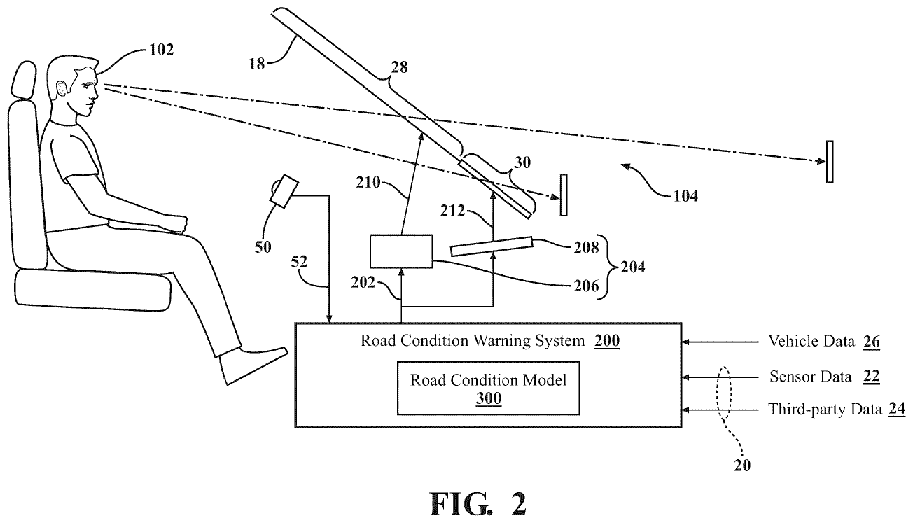

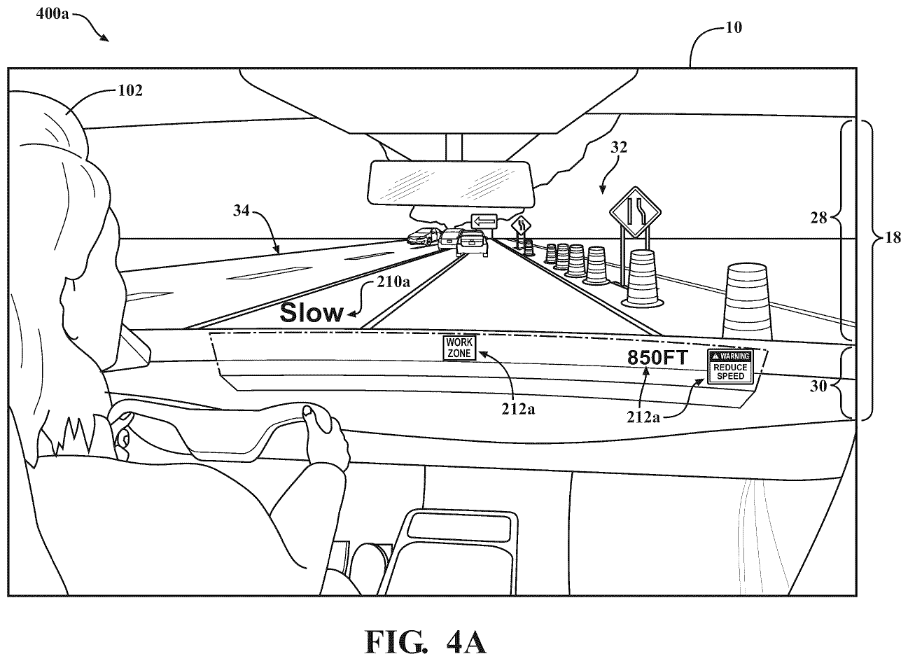

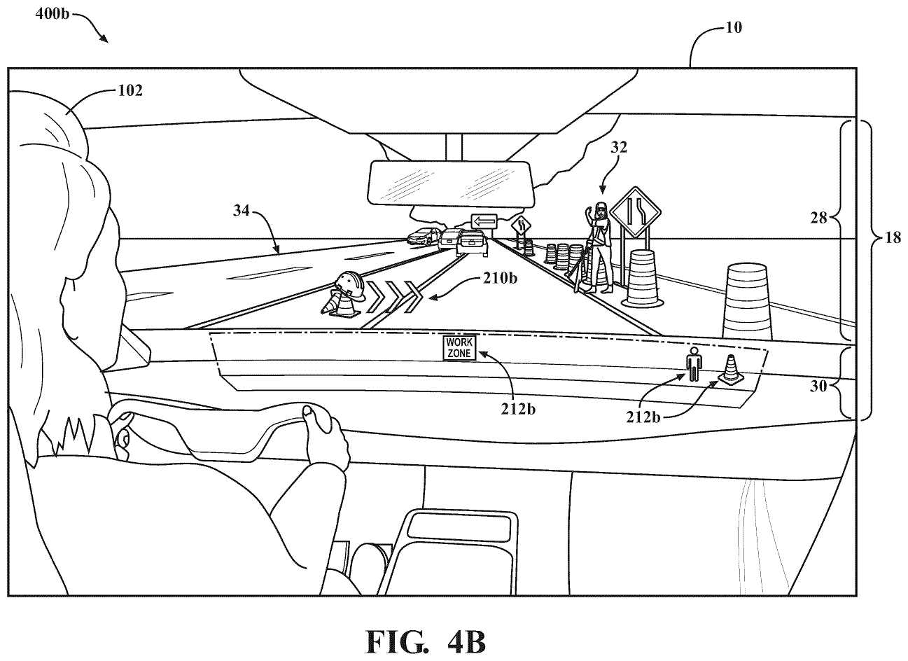

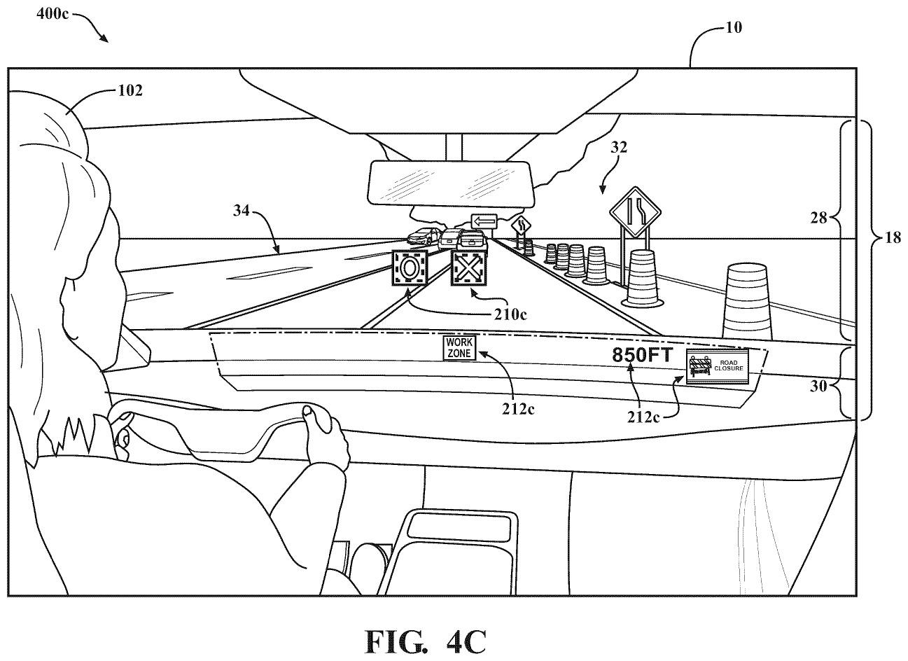

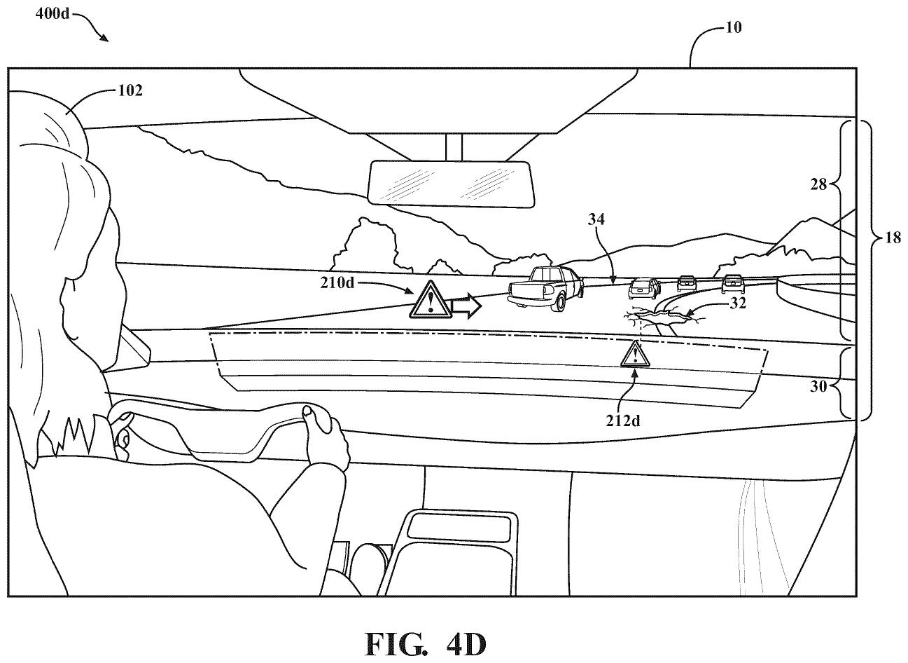

Referring to FIG. 1, in some implementations, a system 100 includes a vehicle 10 and/or a remote system 60 in communication with the vehicle 10 via a network 40. The vehicle 10 and/or the remote system 60 execute a road condition warning system 200 (FIG. 2), and may be driving on a roadway 34 (FIGS. 4A-4D). Briefly, and as described in further detail below, the road condition warning system 200 is configured to receive road data 20 indicating that a road hazard 32 is moving toward the vehicle 10, and, when the road hazard 32 is within the roadway 34 of the vehicle 10, displaying, via head-up displays 204, a graphical alert 202 alerting the driver 102 to the road hazard 32.

As used herein, a road hazard 32 may include an object disposed on a surface or below a surface of the roadway 34. Such as, for example, one or more other vehicles (e.g., a crash) a pothole, an animal or object, a fire, rocks, poor traction, and the like. In some implementations, the road hazard 32 may include a work zone including one or more of a reduced speed zone, construction barrels, road workers, and lane closures. Notably, in either situation, by alerting the driver 102 to the road hazard 32 that is within the roadway 34 of the vehicle 10, the driver 102 is given time to take one or more corrective actions. For example, when the road hazard 32 is a pothole, the graphical alert 202 may provide the driver 102 with enough time to change lanes to avoid the pothole. Similarly, when the road hazard 32 is a work zone, the graphical alert 202 may provide the driver 102 with enough time to either reduce the speed of the vehicle 10 or change lanes. Moreover, the graphical alerts 202 generated by the road condition warning system 200 may provide additional situational awareness in automated driving modes that increases user trust and aids in vehicle take-over.

In the examples shown, the road condition warning system 200 is implemented within a vehicle 10. However, the road condition warning system 200 can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 includes data processing hardware 12 and memory hardware 14 storing instructions that when executed on the data processing hardware 12 cause the data processing hardware 12 to perform operations. Additionally, the vehicle 10 includes a driver tracker system 50 configured to capture the eye positioning of the driver 102 while driving the vehicle 10 and determine the driver features 52 of the driver 102. Here, the driver features 52 may include the eye position, head position, or body position of the driver 102. In particular, the driver tracker system 50 may include a facial imaging camera disposed within the vehicle 10 that continually tracks the eyes of the driver 102 to determine the direction at which the driver's eyes are focused. The facial imaging camera may be configured to take images or video of the face of the driver 102 while driving, and extract the eye position, head position, and/or body position of the driver 102 from the images/video. In other implementations, the driver tracker system 50 includes a sensor (e.g., an optical sensor) configured to determine the movement of the eyes of the driver 102 using light reflected from the cornea of the eye.

The driver features 52 may be used to establish the line of sight 104 of the driver 102. In other words, the driver features 52 may indicate where the driver 102 is looking, which, together with the peripheral vision of the driver 102, may form the line of sight 104 of the driver 102. As used herein, the line of sight 104 of the driver 102 may generally refer to the positioning of the road hazard 32 with respect to the vehicle 10 in real time, such that a vehicle occupant (e.g., the driver 102) can perceive the road hazard 32 when the vehicle occupant is facing toward the front of the vehicle 10. Perception of the road hazard 32 may be based, at least in part, on where the vehicle occupant is sitting inside the vehicle 10, and includes areas outside the vehicle 10 that are naturally observable when the vehicle occupant's head is facing toward the front of the vehicle 10. These areas may also include areas outside of the vehicle 10 that are naturally observable when the vehicle occupant's head turns from the neck to the right and to the left. An example of the line of sight 104 of the driver 102 is shown in FIG. 2, where the dotted arrows bound the line of sight 104, and where road hazards 32 located within the line of sight 104 are perceivable by the driver 102 when the driver 102 is facing toward the front of the vehicle 10. In some implementations, the line of sight 104 is a conical area in the direction of motion of the vehicle 10 ahead of the vehicle with a 120-degree field of view. The line of sight 104 may further extend roughly 800 meters in distance from the driver 102. In other implementations, the line of sight 104 is dynamic based on the geographic region and weather in which the vehicle 10 is driving.

As shown in FIGS. 1 and 2, the vehicle 10 is configured to receive the road data 20, which may include sensor data 22 and third-party data 24. To implement this, the vehicle 10 further includes a sensor system 16 configured to capture/receive the sensor data 22. The sensor system 16 may include one or more of cameras, radio detection and ranging (RADAR), light detection and ranging (LIDAR) capable of capturing image data, and other external sensors of the vehicle 10. While the sensor system 16 shown in FIG. 1 is disposed on a front side of the vehicle, it should be appreciated that the sensor system 16 may include sensors located throughout the vehicle. For example, the sensor system 16 may provide 360-degree surround sensing of an environment of the vehicle 10. The third-party data 24 may include data identifying known conditions of the roadway 34 such as data received from vehicle-to-everything (V2x), cellular data, dedicated short-range communications (DSRC), global positioning system (GPS), wireless communications (e.g., the network), a road database, mobile map applications that crowd-source road conditions, and/or beacons transmitted from work zones identifying the work zone to the vehicle 10.

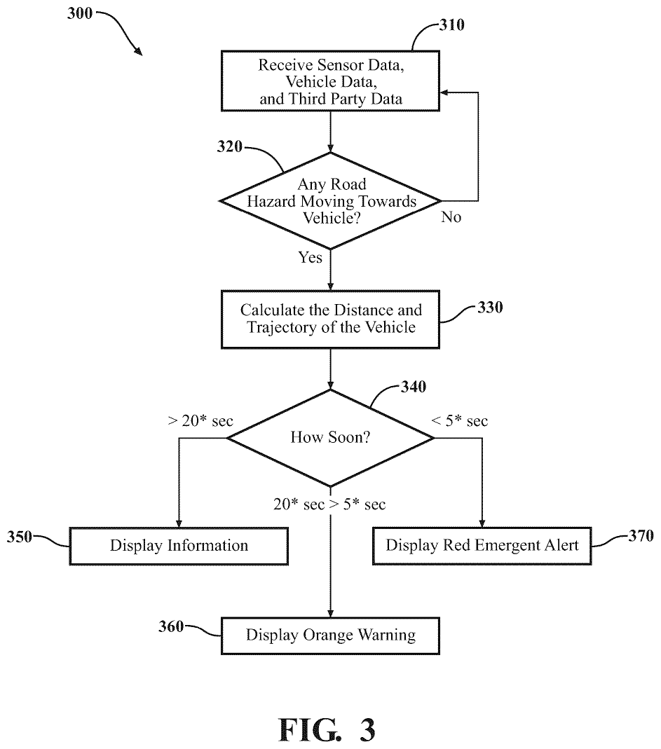

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the road condition warning system 200 is shared across the vehicle 10 and the remote system 60. As described in greater detail below with reference to FIGS. 2 and 3, the road condition warning system 200 executing on the vehicle 10 and/or the remote system 60 executes a road condition model 300 that is configured to receive the road data 20 indicating that a road hazard 32 is moving toward the vehicle 10 and generate the graphical alert 202 when the road data 20 indicates that the vehicle 10 will interact with the road hazard 32 (i.e., is on the roadway 34 of the vehicle 10). For example, the vehicle interaction may include making contact (i.e., hitting) the road hazard 32, and/or passing through a road hazard 32 (i.e., a work zone). In either scenario, the safety of the driver 102, the vehicle 10, and any surrounding vehicles and/or pedestrians is significantly improved when the driver 102 is given advance notice (i.e., via the graphical alert 202) of the road hazard 32.

As shown in FIGS. 1 and 2, the vehicle 10 further includes a windshield 18 providing pillar-to-pillar display capabilities for the road condition warning system 200. In particular, the windshield 18 includes a clear portion 28 and a blackout portion 30. The clear portion 28 may generally refer to the portion of the windshield 18 through which the driver 102 perceives areas outside the vehicle 10. The blackout portion 30 may generally refer to an opaque or blacked out area of the windshield 18 where an instrument cluster and/or infotainment device may be displayed using one or more of, for example, a vacuum fluorescent display (VFP), a light emitting diode (LED) display, a driver information center display, a radio display, an arbitrary text device, a head-up display (HUD), a touchscreen display, a liquid crystal display (LCD), etc.

Referring to FIGS. 1-3, while the vehicle 10 is moving, the vehicle 10 executes the road condition model 300 that receives, as input, the road data 20 including one or more of sensor data 22 detected by the sensor system 16 of the vehicle 10 and the third party data 24. The sensor data 22 may include one or more data fragments or image data detected by the sensor system 16 and may indicate that a road hazard 32 is moving toward the vehicle 10. Additionally or alternatively, the third party data 24 may include an indication of an upcoming road hazard 32 (e.g., a pothole or a work zone). The road condition warning system 200 may additionally receive vehicle data 26 including a direction of the vehicle 10, a velocity of the vehicle 10, a steering angle of the vehicle 10, an acceleration of the vehicle 10, a braking of the vehicle 10, automated driving system outputs of the vehicle 10, and/or a current location of the vehicle 10. The road condition warning system 200 executing the road condition model 300 then determines whether the road hazard 32 is in a roadway 34 of the of the vehicle 10, and, based on the driver features 52 detected by the driver tracker system 50 generates, for output to the head-up displays 204, the graphical alert 202.

Referring to FIG. 3, the road condition model 300 is shown. Here, as the vehicle 10 is moving, the road condition model 300 continuously receives/processes the road data 20 including the sensor data 22 detected by the sensor system 16 and the third party data 24, the vehicle data 26, and the driver features 52 to determine whether to output the graphical alert 202 to the head-up displays 204. At operation 310, the road condition model 300 receives the road data 20 including the sensor data 22 detected by the sensor system 16 and the third party data 24 and the vehicle data 26 of the vehicle 10. The road condition model 300 then determines, at operation 320, whether any road hazards 32 are detected that are moving toward the vehicle 10. For example, the road condition model 300 may determine whether any road data 20 indicates that road hazards 32 are approaching the vehicle 10 based on a location of the vehicle 10 and a location of the road hazards 32. When the road condition model 300 determines that a road hazard 32 is moving toward the vehicle 10, the operations further include, at operation 330, calculating the distance between the road hazard 32 and the vehicle 10, and a trajectory of the vehicle 10. Here, the trajectory of the vehicle 10 may refer to a position, a direction and/or a velocity of the vehicle based on the current vehicle data 26. Here, the vehicle data 26 may be measured/reported by an inertial measurement unit (IMU). In some implementations, at operation 330, the road condition model 300 further determines whether the road hazard 32 and the vehicle 10 will interact. For example, the road condition model 300 determines whether the vehicle 10 will make contact (e.g., hit or collide with) the road hazard 32 or pass through the road hazard 32 (e.g., a work zone).

At operation 340, the road condition model 300 determines how soon the vehicle 10 and the road hazard 32 will interact. In other words, the road condition model 300 determines, based on the distance between the road hazard 32 and the vehicle 10 and the trajectory of the vehicle 10, a time to interaction between the road hazard 32 and the vehicle 10, where the vehicle 10 and the road hazard 32 are co-located. In these implementations, the graphical alert 202 may be generated based on the time to interaction between the road hazard 32 and the vehicle 10. In other words, the graphical alert 202 may be configured based on the urgency indicated by the time to interaction between the road hazard 32 and the vehicle 10. In particular, the size, prominence, colors, gradient, and/or flashing of the graphical alert 202 may change based on the urgency indicated by the time to interaction between the road hazard 32 and the vehicle 10. The urgency indicated by the time to interaction between the road hazard 32 and the vehicle 10 may include the distance between the road hazard 32 and the vehicle 10, a rate of approach of the vehicle 10, and/or the severity of the hazard 32 (e.g., animal crossing versus wildfire). As such, the graphical alert 202 may be configured to convey one or more of the distance between the vehicle 10 and the road hazard 32, the rate of approach of the vehicle 10, a severity of the road hazard 32, and/or a type of the road hazard.

As shown in FIG. 3, when the time to interaction between the road hazard 32 and the vehicle 10 is longer (e.g., greater than twenty (20) seconds), and therefore less urgent, the road condition model 300 may generate/display, at operation 350, a graphical alert 202 that notifies the driver 102 about the upcoming road hazard 32. For example, the upcoming road hazard 32 may be outside of the line of sight 104 of the driver 102. Here, the graphical alert 202 that warns the driver 102 may use smaller graphics, colors and/or flashing elements to notify the driver 102 about the road hazard 32. When the time to interaction between the road hazard and the vehicle is intermediate (e.g., between twenty (20) seconds and five (5) seconds), and therefore somewhat imminent, the road condition model 300 may generate/display, at operation 360, a graphical alert 202 that alerts the driver 102 to the upcoming road hazard 32. Here, the graphical alert 202 that warns the driver 102 may use larger graphics, brighter colors (e.g., orange) and/or flashing elements to notify the driver 102 about the approaching road hazard 32. Alternatively, when the time to collision between the road hazard 32 and the vehicle 10 is shorter (e.g., less than five (5) seconds), and therefore imminent and urgent, the road condition model 300 may generate/display, at operation 370, a graphical alert 202 that warns the driver 102 about the imminent road hazard 32. Here, the graphical alert 202 that warns the driver 102 may use larger graphics, brighter/bolder colors (e.g, red) and/or flashing elements to indicate that the imminent road hazard 32 is urgent.

Referring again to FIG. 2, after the road condition model 300 determines that the road hazard 32 and the vehicle 10 will interact, the road condition warning system 200 generates the graphical alert 202. In particular, the road condition warning system 200 outputs the graphical alert 202 to the head-up displays 204. Here, the graphical alert 202 is modified/configured based on the driver features 52 (e.g., the eye positioning of the driver 102). In particular, the road condition warning system 200 generates the graphical alert 202 based on the driver features 52 and a concavity of the windshield 18 of the vehicle 10 to adjust the rendering of the graphical alert 202 on the windshield 18 as the driver 102 scans the roadway 34. Here, when the driver features 52 indicate that the driver 102 is looking in a particular direction, the road condition warning system 200 may update the xyz positions on the windshield 18 in which the graphical alert 202 is to be projected by the head-up displays 204. For example, when the driver features 52 indicate that the driver 102 is scanning the roadway 34 between right and left (e.g., laterally), the graphical alert 202 may, based on the driver features 52, laterally slide a portion of the graphical alert 202 along the windshield 18. Similarly, when the roadway 34 curves or otherwise changes from straight-line, the driver features 52 may cause the road condition warning system 200 to shift the graphical alert 202 to align with the eye position of the driver 102 within the line of sight 104 of the driver 102.

As shown, the head-up displays 204 include an augmented reality head-up display 206 and a blackout head-up display 208, where the augmented reality head-up display 206 is configured to project images onto the clear portion 28 of the windshield 18 and the blackout head-up display 208 is configured to project images onto the blackout portion 30 of the windshield 18. The graphical alert 202 may generally include an augmented reality image overlay 210 and a virtual image 212 that are each projected by the respective components of the head-up displays 204. For example, the augmented reality head-up display 206 may receive the graphical alert 202 including the augmented reality image overlay 210, and based on the xyz position determined from the driver features 52, project the augmented reality image overlay 210 onto the clear portion 28 of the windshield in a location on the windshield 18 within the line of sight 104 of the driver 102. In some implementations, the augmented reality image overlay 210 indicates a direction of the road hazard 32. Similarly, the blackout head-up display 208 may be configured to display images on the blackout portion 30 of the windshield 18. In particular, the blackout head-up display 208 may receive the graphical alert 202 including the virtual image 212 and project the virtual image 212 onto the blackout portion 30 of the windshield 18, where the virtual image 212 is aligned laterally along the blackout portion 30 with the road hazard 32 on the roadway 34. Here, the augmented reality image overlay 210 and the virtual image 212 are projected onto the windshield 18 simultaneously.

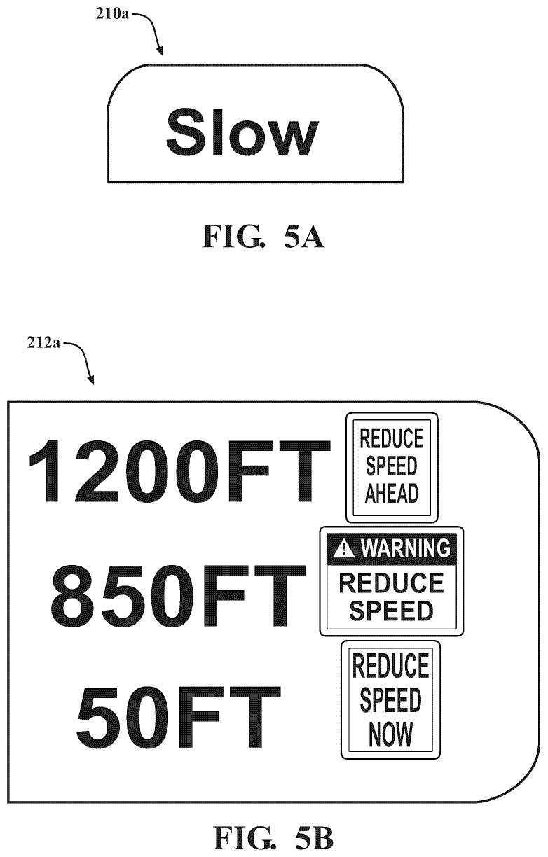

Referring to FIGS. 4A-4D, example components 400a-400d are shown and include the vehicle 10 executing the road condition warning system 200 to warn the driver 102 that a road hazard 32 is approaching the vehicle 10. By warning the driver 102 (i.e., via the graphical alert 202), the driver 102 is given additional time to react to/avoid the road hazard 32. It should be appreciated that the graphical alert 202 projected onto the windshield 18 may be configured/modified base on the urgency of the time to interaction between the road hazard 32 and the vehicle 10. For example, the graphical alert 202 may employ images in varying sizes, colors, and/or use other alert techniques to capture the attention of the driver 102 without pulling the attention of the driver 102 from the road. Additionally, FIGS. 5A-8B include example augmented reality image overlays 210a-210d the virtual images 212a-212d that correspond to the examples components 400a-400d set forth in FIGS. 4A-4D. As described above, the augmented reality image overlay 210 and the virtual image 212 are projected onto the windshield simultaneously, and the augmented reality image overlay 210 may be different from the virtual image 212.

With reference to FIGS. 4A, 5A, and 5B, the road condition warning system 200 may detect, based on the road data 20, that the vehicle 10 is approaching a road hazard 32 (e.g., a work zone) in the roadway 34. For example, the road hazard 32 may include a work zone with a reduced speed zone, where the driver 102 needs to decelerate the vehicle 10 to a safer speed to comply with work zone regulations as well as increase the safety to the workers and other drivers. In response to detecting the road hazard 32, the road condition warning system 200 generates, based on the driver features 52 detected by the driver tracker system 50, the graphical alert 202 including an augmented reality image overlay 210a and a virtual image 212a. As shown, the augmented reality image overlay 210a is projected onto the clear portion 28 of the windshield 18 in a location on the windshield 18 within the line of sight 104 of the driver 102 such that the augmented reality image overlay 210a appears to be positioned on the road in front of the vehicle 10, and includes the term “slow” to alert the driver 102 to decelerate the velocity of the vehicle 10. Simultaneously, the virtual image 212a is projected onto the blackout portion 30 of the windshield 18 to indicate the road hazard 32. As shown, the virtual image 212a includes a “work zone” notification, a distance (i.e., 850 feet) to the road hazard 32, and a warning to “reduce speed.”

With particular reference to FIG. 5A, the augmented reality image overlay 210a of “slow” may be displayed in different colors (e.g., red, orange, yellow, green), sizes, or gradients based an urgency defined by the distance between the road hazard 32 and the vehicle 10 and/or the velocity of the vehicle 10. Similarly, as shown in FIG. 5B, the virtual image 212a may be updated/changed based on the urgency defined by the distance between the road hazard 32 and the vehicle 10 and/or the velocity of the vehicle 10. For example, the virtual image 212a may update to reflect the change in distance between the road hazard 32 and the vehicle 10 as the vehicle 10 approaches the work zone (i.e., the road hazard 32). Likewise, the virtual image 212a may include escalating warning signs, from merely notifying the driver 102 with “reduce speed ahead,” to warning the driver 102 with “warning reduce speed,” to urging the driver 102 with “reduce speed now.”

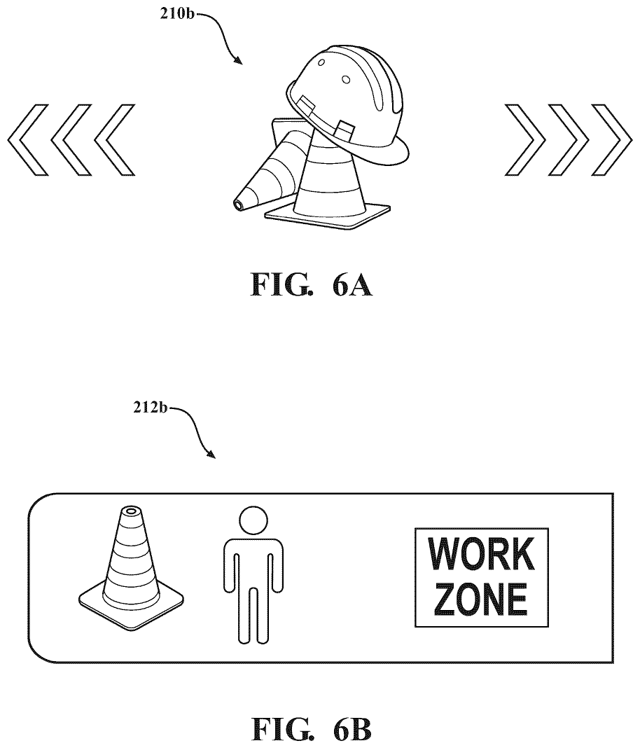

With reference to FIGS. 4B, 6A, and 6B, the road condition warning system 200 may detect, based on the road data 20, that the vehicle 10 is approaching a road hazard 32 (e.g., a work zone). For example, the road hazard 32 may include a work zone with workers present on the roadway 34 or directly adjacent to the roadway 34, where the driver 102 should take particular care when passing the road hazard 32 (i.e., the work zone) such as, to decelerate the vehicle 10 to a safer speed to comply with work zone regulations as well as increase the safety to the workers and other drivers. In response to detecting the road hazard 32, the road condition warning system 200 generates, based on the driver features 52 detected by the driver tracker system 50, the graphical alert 202 including an augmented reality image overlay 210b and a virtual image 212b. As shown, the augmented reality image overlay 210b is projected onto the clear portion 28 of the windshield 18 in a location on the windshield 18 within the line of sight 104 of the driver 102 such that the augmented reality image overlay 210b appears to be positioned on the roadway 34 in front of the vehicle 10, and includes a graphic indicating construction (e.g., a cone and helmet), as well as directional arrows pointing to the right to alert the driver 102 to the work zone worker on the right of the roadway 34. Simultaneously, the virtual image 212b is projected onto the blackout portion 30 of the windshield 18 to indicate the road hazard 32. As shown, the virtual image 212b includes a “work zone” notification, a graphic indicating a person (i.e., the work zone worker), and a graphic indicating traffic cones.

With particular reference to FIG. 6A, the augmented reality image overlay 210b of a graphic indicating construction (e.g., a cone and helmet) may be displayed in different colors (e.g., red, orange, yellow, green), sizes, or gradients based an urgency defined by the distance between the road hazard 32 and the vehicle 10 and/or the velocity of the vehicle 10. Additionally, the directional arrows may indicate a direction (i.e., left or right) of the road hazard 32 relative to the vehicle 10. Similarly, as shown in FIG. 6B, the virtual image 212b may be updated/changed based on the urgency defined by the distance between the road hazard 32 and the vehicle 10 and/or the velocity of the vehicle 10.

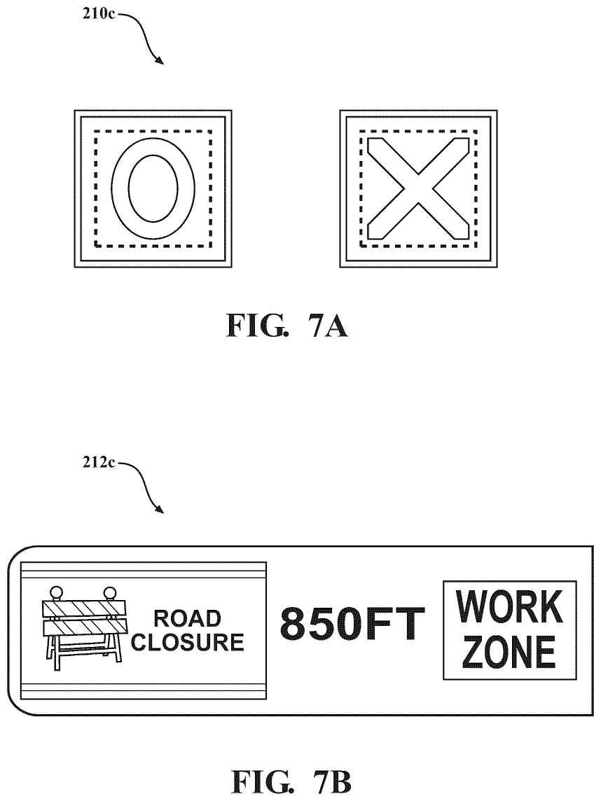

With reference to FIGS. 4C, 7A, and 7B, the road condition warning system 200 may detect, based on the road data 20, that the vehicle 10 is approaching a road hazard 32 (e.g., a work zone) in the roadway 34. For example, the road hazard 32 may include a work zone with a lane closure, where the driver 102 needs to merge the vehicle 10 into an adjacent lane to a safer speed to comply with work zone regulations as well as maintain the safety to the workers and other drivers. In response to detecting the road hazard 32, the road condition warning system 200 generates, based on the driver features 52 detected by the driver tracker system 50, the graphical alert 202 including an augmented reality image overlay 210c and a virtual image 212c. As shown, the augmented reality image overlay 210c is projected onto the clear portion 28 of the windshield 18 in a location on the windshield 18 within the line of sight 104 of the driver 102 such that the augmented reality image overlay 210c appears to be positioned on the road in front of the vehicle 10, and includes graphics indicating open (i.e., a circle) and closed (i.e., a cross) lanes to alert the driver 102 to change lanes from the closed lane to an open lane. Notably, the open graphic is displayed to overlay the portion of the roadway 34 that includes an open lane, while the closed graphic is displayed to overlay the portion of the roadway 34 that includes the upcoming closed lane. Simultaneously, the virtual image 212c is projected onto the blackout portion 30 of the windshield 18 to indicate the road hazard 32. As shown, the virtual image 212a includes a “work zone” notification, a distance (i.e., 850 feet) to the road hazard 32, and a warning of a “road closure”.

With particular reference to FIG. 7A, the augmented reality image overlay 210c including the graphics indicating open (i.e., a circle) and closed (i.e., a cross) lanes may be displayed in different colors (e.g., red, orange, yellow, green), sizes, or gradients based an urgency defined by the distance between the road hazard 32 and the vehicle 10 and/or the velocity of the vehicle 10. Similarly, as shown in FIG. 6B, the virtual image 212c may be updated/changed based on the urgency defined by the distance between the road hazard 32 and the vehicle 10 and/or the velocity of the vehicle 10.

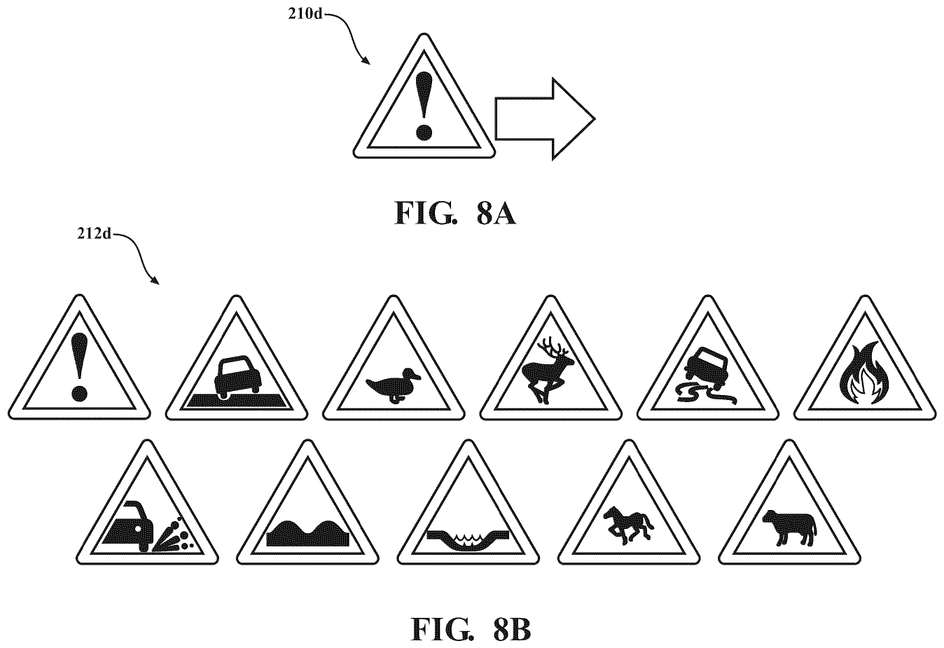

With reference to FIGS. 4D, 8A, and 8B, the road condition warning system 200 may detect, based on the road data 20, that the vehicle 10 is approaching a road hazard 32 (e.g., a pothole) in the roadway 34. For example, the road hazard 32 may include a work zone with a pothole disposed on a lane marker, where the driver 102 may wish to swerve to avoid the pothole without impacting other drivers. In response to detecting the road hazard 32, the road condition warning system 200 generates, based on the driver features 52 detected by the driver tracker system 50, the graphical alert 202 including an augmented reality image overlay 210d and a virtual image 212d. As shown, the augmented reality image overlay 210d is projected onto the clear portion 28 of the windshield 18 in a location on the windshield 18 within the line of sight 104 of the driver 102 such that the augmented reality image overlay 210d appears to be positioned on the road in front of the vehicle 10, and includes a graphic of a generic alert symbol as well as a directional arrow pointing to the right to alert the driver 102 to the pothole (i.e., the road hazard 32) on the right side of the vehicle 10. Simultaneously, the virtual image 212d is projected onto the blackout portion 30 of the windshield 18 to indicate the road hazard 32. As shown, the virtual image 212d includes a generic alert symbol without directional arrows. Rather, the blackout head-up display 208 laterally aligns the virtual image 212d along the blackout portion 30 of the windshield 18 with the road hazard 32 based on the driver features 52 indicating the location of the windshield 18 that the driver 102 is looking at. Notably, as the vehicle 10 moves with respect to the road hazard 32, and/or as the driver 102 scans the roadway 34, the virtual image 212d may slide laterally along the blackout portion 30 to maintain alignment with the road hazard 32.

With particular reference to FIG. 8A, the augmented reality image overlay 210d of the graphic of the generic alert symbol as well as the directional arrow may be displayed in different colors (e.g., red, orange, yellow, green), sizes, or gradients based an urgency defined by the distance between the road hazard 32 and the vehicle 10 and/or the velocity of the vehicle 10. Similarly, as shown in FIG. 8B, the virtual image 212d may be updated/changed based on the urgency defined by the distance between the road hazard 32 and the vehicle 10 and/or the velocity of the vehicle 10. Optionally, the virtual image 212d may be updated/changed based on the type of road hazard 32 is approaching the vehicle 10. For example, based on the road data 20, the road condition warning system 200 may detect via images and/or image fragments, or third-party reports, what type of road hazard 32 is present. In response, the road condition warning system 200 generate the graphical alert 202 including the virtual image 212d including the type of road hazard 32. The type of road hazard 32 may refer to standard road hazards such as, without limitation, animal crossing, pothole, deer crossing, low traction, fire, falling rocks, etc.

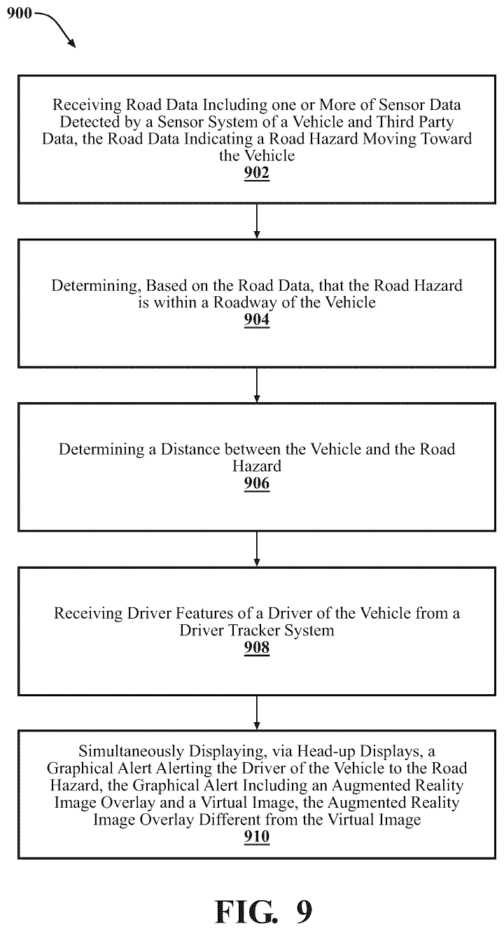

FIG. 9 includes a flowchart of an example arrangement of operations for a method 900 for a road condition warning on reflective and augmented head-up displays. The method 900 may be described with reference to FIGS. 1-8A. Data processing hardware (e.g., data processing hardware 12, 62 of FIG. 1) may execute instructions stored on memory hardware (e.g., memory hardware 14, 64 of FIG. 1) to perform the example arrangement of operations for the method 900.

At operation 902, the method 900 includes receiving road data 20 including one or more of sensor data 22 detected by a sensor system 16 of the vehicle 10 and third party data 24. The road data 20 may indicate a road hazard 32 moving toward the vehicle 10. At operation 904, the method 900 also includes determining, based on the road data 20, that the road hazard 32 is within a roadway 34 of the vehicle 10. At operation 906, the method 900 further includes determining a distance between the vehicle 10 and the road hazard 32.

The method 900 also includes, at operation 908, receiving driver features 52 of a driver 102 of the vehicle 10 from a driver tracker system 50. At operation 910, the method 900 further includes simultaneously displaying, via head-up displays 204, a graphical alert 202 alerting the driver 102 of the vehicle 10 to the road hazard 32. Here, the graphical alert 202 includes an augmented reality image overlay 210 and a virtual image 212, where the augmented reality image overlay 210 is different from the virtual image 212.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving road data including one or more of sensor data detected by a sensor system of a vehicle and third party data, the road data indicating a road hazard moving toward the vehicle;
determining, based on the road data, that the road hazard is within a roadway of the vehicle;
determining a distance between the vehicle and the road hazard;
receiving driver features of a driver of the vehicle from a driver tracker system;
simultaneously displaying, via head-up displays, a graphical alert alerting the driver of the vehicle to the road hazard, the graphical alert including an augmented reality image overlay and a virtual image, the augmented reality image overlay different from the virtual image.

2. The method of claim 1, wherein the head-up displays include an augmented reality head-up display and a blackout head-up display.

3. The method of claim 2, wherein simultaneously displaying, via the head-up displays, the graphical alert alerting the driver of the vehicle to the road hazard comprises:
generating the augmented reality image overlay;
generating the virtual image; and
projecting the augmented reality image overlay and the virtual image on a windshield of the vehicle simultaneously.

4. The method of claim 3, wherein projecting the augmented reality image overlay and the virtual image on the windshield of the vehicle simultaneously comprises projecting the augmented reality image overlay on a clear portion of the windshield and projecting the virtual image on a blackout portion of the windshield.

5. The method of claim 3, wherein projecting the augmented reality image overlay and the virtual image on a windshield of the vehicle simultaneously comprises:
determining, based on the driver features, a location of the windshield that corresponds to a line of sight of the driver; and
projecting the augmented reality image overlay on the location of the windshield that corresponds to the line of sight of the driver.

6. The method of claim 1, wherein the sensor system comprises one or more of:
cameras;
radio detection and ranging (RADAR); and
light detection and ranging (LIDAR).

7. The method of claim 1, wherein the operations further comprise:
receiving vehicle data;
calculating, based on the vehicle data, a trajectory of the vehicle; and
determining whether the road hazard and the vehicle will interact.

8. The method of claim 7, wherein the operations further comprise:
determining, based on the distance between the vehicle and the road hazard and the trajectory of the vehicle, a time to interaction between the road hazard and the vehicle; and
generating the graphical alert based on the time to interaction between the road hazard and the vehicle.

9. The method of claim 1, wherein displaying, via the head-up displays, the graphical alert alerting the driver of the vehicle to the road hazard comprises displaying the graphical alert on a windshield of the vehicle to indicate a location of the road hazard.

10. The method of claim 1, wherein the graphical alert is configured to convey one or more of:
a distance to the road hazard;
a rate of approach of the road hazard;
a severity of the road hazard; and
a type of the road hazard.

11. A system comprising:
data processing hardware; and
memory hardware in communication with the data processing hardware, the memory hardware storing instructions that when executed on the data processing hardware cause the data processing hardware to perform operations comprising:
receiving road data including one or more of sensor data detected by a sensor system of a vehicle and third party data, the road data indicating a road hazard moving toward the vehicle;
determining, based on the road data, that the road hazard is within a roadway of the vehicle;
determining a distance between the vehicle and the road hazard;
receiving driver features of a driver of the vehicle from a driver tracker system;
simultaneously displaying, via head-up displays, a graphical alert alerting the driver of the vehicle to the road hazard, the graphical alert including an augmented reality image overlay and a virtual image, the augmented reality image overlay different from the virtual image.

12. The system of claim 11, wherein the head-up displays include an augmented reality head-up display and a blackout head-up display.

13. The system of claim 12, wherein simultaneously displaying, via the head-up displays, the graphical alert alerting the driver of the vehicle to the road hazard comprises:
generating the augmented reality image overlay;
generating the virtual image; and
projecting the augmented reality image overlay and the virtual image on a windshield of the vehicle simultaneously.

14. The system of claim 13, wherein projecting the augmented reality image overlay and the virtual image on the windshield of the vehicle simultaneously comprises projecting the augmented reality image overlay on a clear portion of the windshield and projecting the virtual image on a blackout portion of the windshield.

15. The system of claim 13, wherein projecting the augmented reality image overlay and the virtual image on a windshield of the vehicle simultaneously comprises:
determining, based on the driver features, a location of the windshield that corresponds to a line of sight of the driver; and
projecting the augmented reality image overlay on the location of the windshield that corresponds to the line of sight of the driver.

16. The system of claim 11, wherein the sensor system comprises one or more of:
cameras;
radio detection and ranging (RADAR); and
light detection and ranging (LIDAR).

17. The system of claim 11, wherein the operations further comprise:
receiving vehicle data;
calculating, based on the vehicle data, a trajectory of the vehicle; and
determining whether the road hazard and the vehicle will interact.

18. The system of claim 17, wherein the operations further comprise:
determining, based on the distance between the vehicle and the road hazard and the trajectory of the vehicle, a time to interaction between the road hazard and the vehicle; and
generating the graphical alert based on the time to interaction between the road hazard and the vehicle.

19. The system of claim 11, wherein displaying, via the head-up displays, the graphical alert alerting the driver of the vehicle to the road hazard comprises displaying the graphical alert on a windshield of the vehicle to indicate a location of the road hazard.

20. The system of claim 11, wherein the graphical alert is configured to convey one or more of:
a distance to the road hazard;
a rate of approach of the road hazard;
a severity of the road hazard; and
a type of the road hazard.
